(19) United States
(12) Patent Application Publication
(10) Pub. No.: US 2017/0109371 A1
(43) Pub. Date: Apr. 20, 2017

(54) Method and Apparatus for Processing File in a Distributed System

(71) Applicant: BEIJING BAIDU NETCOM SCIENCE AND TECHNOLOGY, LTD., Beijing (CN)

(72) Inventor: Quangang Zheng, Beijing (CN)

(73) Assignee: BEIJING BAIDU NETCOM SCIENCE AND TECHNOLOGY, LTD., Beijing (CN)

(21) Appl. No.: 15/239,646

(22) Filed: Aug. 17, 2016

(30) Foreign Application Priority Data
Oct. 14, 2015 (CN) 201510661956.0

(51) Int. Cl. G06F 17/30; H04L 29/08

(52) U.S. Cl. CPC G06F 17/30203; H04L 67/06; G06F 17/30165

(57) ABSTRACT

The present application discloses a method and apparatus for processing a file in a distributed system. A specific implementation of the method includes: receiving a file having predetermined identifiers; splitting the file into a plurality of subfiles based on a size of the file, a number of the predetermined identifiers in the file and a number of servers in the distributed system, each of the plurality of subfiles comprising an identical number of the predetermined identifiers; and sending, in response to a file processing request sent by at least one of the servers in the distributed system, the plurality of subfiles to a corresponding server for parallel processing of the file. This implementation improves the processing efficiency of a genetic information file, and implements load balancing.

### CROSS-REFERENCE TO RELATED APPLICATION

This application is related to and claims priority from Chinese Application Ser. No. 201510661956.0, filed on Oct. 14, 2015, entitled “METHOD AND APPARATUS FOR PROCESSING FILE IN A DISTRIBUTED SYSTEM” by Beijing Baidu Netcom Science And Technology Co., Ltd., the entire disclosure of which is hereby incorporated by reference.

### TECHNICAL FIELD

The present application relates to the field of computer technology, specifically to the field of Internet technology, and more specifically to a method and apparatus for processing a file in a distributed system.

### BACKGROUND

A user usually checks a processed genetic information file, and predicts his risk of illness based on the processed genetic information file. Because the large size of the genetic information file, the checking and processing of the genetic information file become time-consuming and cumbersome.

In the prior art, the system for processing genetic information files typically includes a single server. Only the single server in the system may be utilized to process the genetic information file, resulting in a long processing time. In addition, when the genetic information file is too large, it may be possible that the system for processing the genetic information file fails to process such a genetic information file due to an insufficient memory.

Therefore, in order to further improve the processing efficiency of the genetic information file, a method for parallel processing the genetic information file is needed.

### SUMMARY

An objective of the present application is to propose an improved method and apparatus for processing a file in a distributed system, to solve the technical problem mentioned in the above Background section.

In a first aspect, the present application provides a file processing method for a distributed system, which includes: receiving a file having predetermined identifiers; splitting the file into a plurality of subfiles based on a size of the file, a number of the predetermined identifiers in the file and a number of servers in the distributed system, each of the plurality of subfiles comprising an identical number of the predetermined identifiers; and sending, in response to a file processing request sent by at least one of the servers in the distributed system, the plurality of subfiles to a corresponding server for parallel processing of the file.

In some embodiments, the number of the plurality of subfiles is an integer multiple of the number of the servers in the distributed system.

In some embodiments, the method further includes, after the sending the plurality of subfiles to the corresponding server for the parallel processing of the file: merging the subfiles processed by the corresponding server to generate a merged file; and setting an access permission of the merged file to a share permission or a non-share permission.

In some embodiments, the file is a genetic information file.

In some embodiments, the splitting the file into the plurality of subfiles based on the size of the file, the number of the predetermined identifiers in the file and the number of the servers in the distributed system comprises: determining a number of the plurality of subfiles to be generated and a number of the predetermined identifiers in each of the plurality of subfiles, based on the size of the file, the number of the predetermined identifiers in the file and the number of the servers in the distributed system; and splitting the file into the plurality of subfiles based on the number of the plurality of subfiles to be generated and the number of the predetermined identifiers in each of the plurality of subfiles.

In a second aspect, the present application provides an apparatus for processing a file in a distributed system, which includes: a receiving unit for receiving a file having predetermined identifiers; a splitting unit for splitting the file into a plurality of subfiles based on a size of the file, a number of the predetermined identifiers in the file and a number of servers in the distributed system, each of the plurality of subfiles comprising an identical number of the predetermined identifiers; and a parallel processing unit for sending, in response to a file processing request sent by at least one of the servers in the distributed system, the plurality of subfiles to a corresponding server for parallel processing of the file.

In some embodiments, the number of the plurality of subfiles is an integer multiple of the number of the servers in the distributed system.

In some embodiments, the parallel processing unit is further configured to: merge the subfiles processed by the corresponding server to generate a merged file; and set an access permission of the merged file to a share permission or a non-share permission.

In some embodiments, the file is a genetic information file.

In some embodiments, the splitting unit is further configured to: determine a number of the plurality of subfiles to be generated and a number of the predetermined identifiers in each of the plurality of subfiles, based on the size of the file, the number of the predetermined identifiers in the file and the number of the servers in the distributed system; and split the file into the plurality of subfiles based on the number of the plurality of subfiles to be generated and the number of the predetermined identifiers in each of the plurality of subfiles.

The method and apparatus for processing the file in the distributed system provided by the embodiments of the present application improve the processing efficiency of a genetic information file, and implement load balancing.

### BRIEF DESCRIPTION OF THE DRAWINGS

Other features, purposes and advantages of the present application will become more apparent from a reading of the detailed description of the non-limiting embodiments, said description being given in relation to the accompanying drawings, among which::

FIG. 1 is an architecture diagram of an exemplary system where the present application may be applied;

FIG. 2 is a flow chart of a method for processing a file in a distributed system according to an embodiment of the present application;

FIG. 3 is a schematic diagram of an application scenario of a method for processing a file in a distributed system according to the present application;

FIG. 4 is a schematic structural diagram of an apparatus for processing a file in a distributed system according to an embodiment of the present application; and

FIG. 5 is a schematic structural diagram of a computer system adapted to implement a terminal device or server according to an embodiment of the present application.

### DETAILED DESCRIPTION OF THE EMBODIMENTS

The following detailed description is provided with reference to the accompanying drawings and embodiments. It should be appreciated that the embodiments described herein are provided to illustrate the present invention, but not to limit the present invention. In addition, it should be noted that only the related parts of the present invention are shown in the accompanying drawings for ease of description.

It should be noted that the embodiments and features of the embodiments in the present application, on a non-conflicting basis, may be combined. The present application will be discussed in details below with reference to the accompanying drawings.

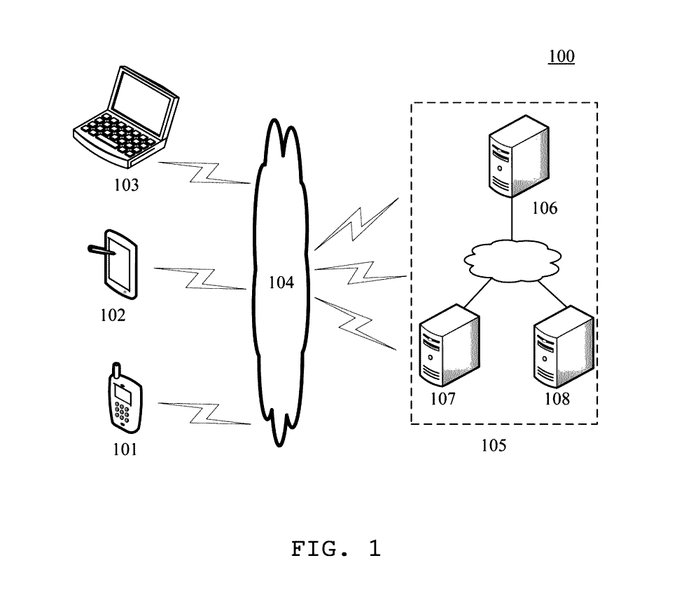

FIG. 1 shows an exemplary system architecture 100 where a method for processing a file in a distributed system or an apparatus for processing a file in a distributed system of an embodiment of the present application may be implemented.

As shown in FIG. 1, the system architecture 100 may include terminal devices 101, 102 and 103, a network 104 and a distributed system 105 (the distributed system 105 includes: servers 106, 107, and 108). The network 104 is configured to provide a medium for communication links between the terminal devices 101, 102, and 103 and the distributed system 105. The network 104 may include various types of connections, such as wired and wireless communication links or fiber connections and cable connections.

Users may use the terminal devices 101, 102 and 103 to interact with the distributed system 105 through the network 104, so as to receive or send messages, etc. A variety of communication client applications may be installed on the terminal devices 101, 102 and 103, such as a file processing application, a shopping application, a search application, an instant messaging tool, an email client, and social platform software.

The terminal devices 101, 102 and 103 may be various electronic devices having display screens and supporting data processing, which include, but are not limited to, a smart phone, a tablet computer, an e-book reader, an MP3 (Moving Picture Experts Group Audio Layer III) player, an MP4 (Moving Picture Experts Group Audio Layer IV) player, a laptop portable computer, and a desktop computer.

The distributed system 105 includes servers 106, 107 and 108. The servers 106, 107 and 108 may be servers for providing a variety of services, such as a back end server for providing support to the files uploaded by the terminal devices 101, 102 and 103. The back end server may be capable of performing processes including analysis on the received data such as a file, and feeding back the processed file to the terminal devices.

It should be noted that the method for processing the file in the distributed system provided in the embodiment of the present application is generally performed by the distributed system 105, and accordingly, the apparatus for processing the file in the distributed system is generally provided in the distributed system 105.

It should be understood that the numbers of the terminal devices, networks, and servers in FIG. 1 are only exemplary. According to implementation requirements, any number of the terminal devices, networks and servers may be provided.

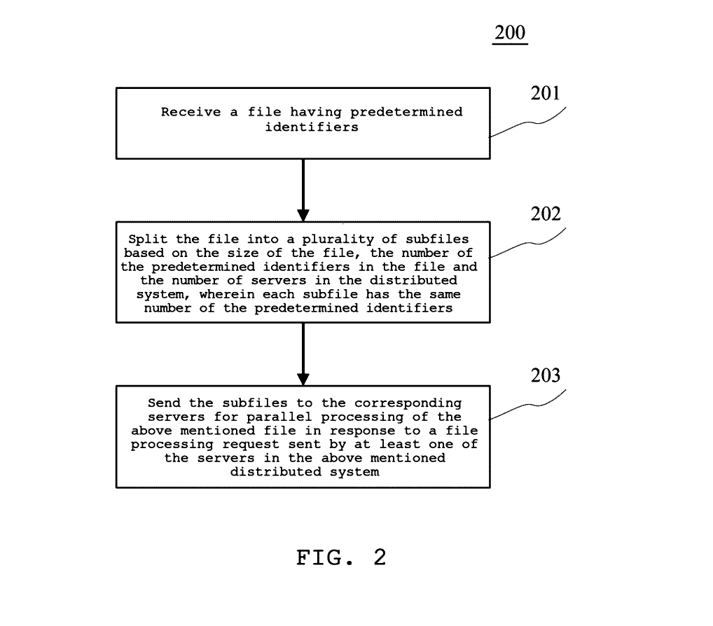

Further referring to FIG. 2, a flow 200 of a method for processing a file in a distributed system according to an embodiment of the present application is shown. The method for processing the file in the distributed system includes the following steps:

Step 201: Receive a file having predetermined identifiers.

In this embodiment, an electronic device (for example, the distributed system 105 as shown in FIG. 1) for implementing the method for processing the file in the distributed system receives, through a wired or wireless connection, the file having the predetermined identifiers from a user through a terminal on which the user browses files. The above mentioned file having the predetermined identifiers comprises a file the user expects to process, and the file has the predetermined identifiers. It should be noted that the above mentioned wireless connection may include, but is not limited to, 3G/4G connection, WiFi connection, Bluetooth connection, WiMAX connection, Zigbee connection, UWB (ultra wideband) connection, and other known or further developed wireless connection.

Generally, the user employs a file processing client installed on the terminal to send a file, and the user may send the file having the predetermined identifiers to the distributed system 105 by directly inputting the content of the file or uploading the file. In this embodiment, the above mentioned file may comprise a file in a fasta format, a fastq format, or other later developed formats; and the above mentioned predetermined identifiers may be “>” or “@”.

In some optional implementations of this embodiment, the above mentioned file is a genetic information file.

Step 202: Split the file into a plurality of subfiles based on the size of the file, the number of the predetermined identifiers in the file and the number of servers in the distributed system, wherein each subfile has the same number of the predetermined identifiers.

In this embodiment, based on the file having the predetermined identifiers obtained at step 201, the above mentioned electronic device (for example, the distributed system 105 as shown in FIG. 1) may acquire the above mentioned file, analyze the above mentioned file and the content of the file by a variety of analytical means to detect the size of the file and the number of the predetermined identifiers in the file, and detect the number of the servers included in the distributed system. Thereafter, the above mentioned file is split into a plurality of subfiles based on the size of the above mentioned file, the number of the predetermined identifiers in the above mentioned file and the number of the servers included in the above mentioned distributed system, and each subfile has the same number of the predetermined identifiers.

In a specific embodiment, assuming that the size of the above mentioned file is 100M, the predetermined identifiers in the above mentioned file are 200 “@”, and the number of the servers included in the above mentioned distributed system is 10, the file is split into 10 subfiles, and each subfile is ensured to include 20 predetermined identifiers.

In some optional implementations of this embodiment, the number of the above mentioned subfiles is an integer multiple of the number of the servers included in the distributed system. As mentioned above, the number of the servers included in the above mentioned distributed system is 10, and thus the number of the subfiles as an integer multiple of 10, such as 10, 20, or 30, is considered. After the number of the subfiles is determined, the file is split into subfiles.

In some optional implementations of this embodiment, the number of the split subfiles to be generated and the number of the predetermined identifiers included in each subfile are determined based on the size of the file, the number of the predetermined identifiers in the file and the number of the servers included in the distributed system; and the file is split into a plurality of subfiles based on the number of the split subfiles to be generated and the number of the predetermined identifiers included in each subfile. As stated above, assuming that the size of the above mentioned file is 100M, the predetermined identifiers in the above mentioned file are 200 “@” and the number of the servers included in the above mentioned distributed system is 10, the above mentioned file is split into a multiple of 10 subfiles, the number of the split subfiles to be generated is determined to be 10, and each subfile includes 20 predetermined identifiers. Based on the number of the split subfiles to be generated and the number of the predetermined identifiers included in each subfile, the file is split into 10 subfiles while each subfile is ensured to include 20 predetermined identifiers.

Step 203: Send the subfiles to the corresponding servers for parallel processing of the above mentioned file in response to a file processing request sent by at least one of the servers in the above mentioned distributed system.

In this embodiment, at least one of the servers included in the above mentioned distributed system sends the file processing request first. The distributed system, upon receiving the above mentioned file processing request, sends the subfiles to the corresponding servers in response to the file processing request so that the at least one of the servers included in the above mentioned distributed system performs parallel processing of the above mentioned file, thereby implementing load balancing of the file processing request by means of the plurality of servers in the distributed system.

In some optional implementations of this embodiment, the subfiles processed by the corresponding servers are merged to generate a merged file. An access permission of the merged file is set to a share permission or a non-share permission. Herein, the file having the predetermined identifiers and the merged file are displayed by way of text or graph. The non-share permission allows default users to download, view, modify, invoke, or delete files; and the share permission allows all the users to read and copy files.

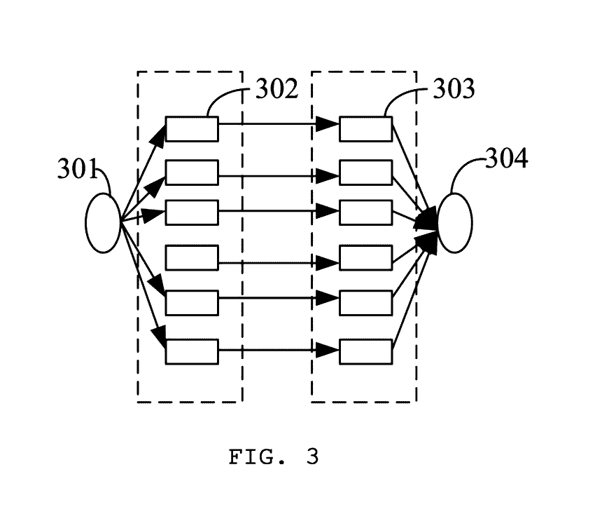

Further reference is made to FIG. 3, which is a schematic view 300 of one application scenario of the method for processing a file in a distributed system according to this embodiment. In the application scenario of FIG. 3, the distributed system first receives a file 301 having predetermined identifiers. The file is then split into a plurality of subfiles 302 based on the size of the above mentioned file 301, the number of the predetermined identifiers in the file 301 and the number of the servers 303 included in the distributed system, wherein each subfile 302 includes the same number of the predetermined identifiers; and sends the subfiles to the corresponding servers 303 for parallel processing of the file in response to a file processing request sent by at least one of the servers 303 included in the distributed system. The subfiles processed by the corresponding servers 303 are merged to generate a merged file 304.

According to the embodiment of the present application, the processing efficiency of a genetic information file is improved, and load balancing is implemented.

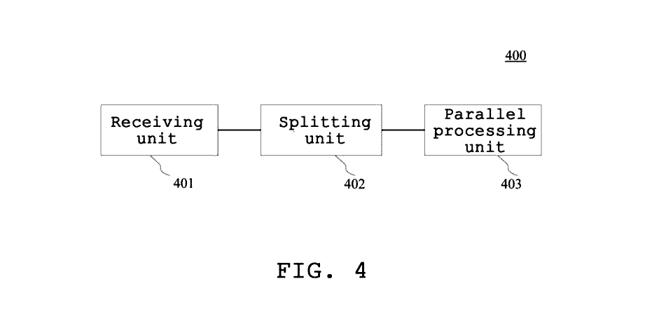

Further referring to FIG. 4, as an implementation of the method shown in the above mentioned figures, the present application provides one embodiment of an apparatus for processing a file in a distributed system, and the apparatus embodiment corresponds to the method embodiment as shown in FIG. 2.

As shown in FIG. 4, the apparatus 400 for processing a file in a distributed system in this embodiment includes: a receiving unit 401, a splitting unit 402, and a parallel processing unit 403. The receiving unit 401 is configured to receive a file having predetermined identifiers. The splitting unit 402 is configured to split the file into a plurality of subfiles based on the size of the file, the number of the predetermined identifiers in the file, and the number of servers in the distributed system, each subfile includes the same number of the predetermined identifiers; and the parallel processing unit 403 is configured to send the subfiles to the corresponding servers for performing parallel processing of the file in response to a file processing request sent by at least one of the servers in the distributed system.

In this embodiment, the receiving unit 401 of the apparatus 400 for processing the file in the distributed system receives, through a wired or wireless connection, the file having the predetermined identifiers from a user by using the terminal on which the user browses files. The above mentioned file having the predetermined identifiers comprises a file the user expects to process, and the file has the predetermined identifiers.

In this embodiment, based on the file obtained by the receiving unit 401, the above mentioned splitting unit 402 may acquire the above mentioned file, analyze the above mentioned file and the content of the file by a variety of analytical means to detect the size of the file and the number of the predetermined identifiers in the file; and then detect to the number of the servers included in the distributed system.

In this embodiment, the parallel processing unit 403 is configured to send the subfiles to the corresponding servers for performing parallel processing of the file in response to a file processing request sent by at least one of the servers in the distributed system.

Persons skilled in the art can understand that, the above mentioned apparatus 400 for process the file in the distributed system further includes other well-known structures, such as a processor and a memory. Such well-known structures are not shown in FIG. 4 to avoid obscuring unnecessarily the embodiments of the disclosure.

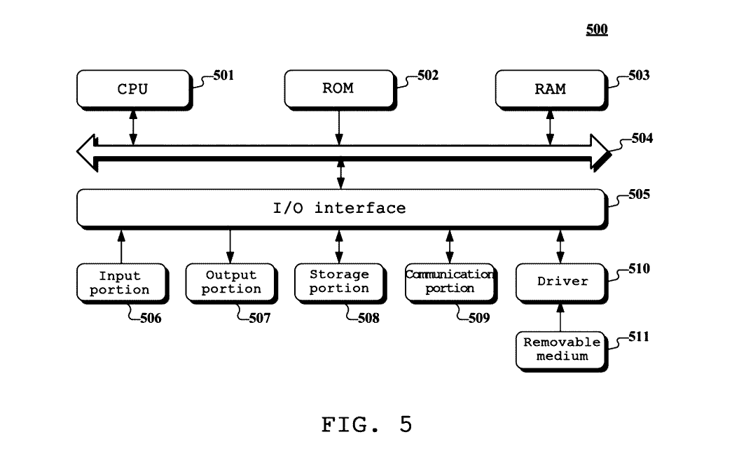

Referring to FIG. 5, a schematic structural diagram of a computer system 500 adapted to implement a terminal apparatus or a server of the embodiments of the present application is shown.

As shown in FIG. 5, the computer system 500 includes a central processing unit (CPU) 501, which may execute various appropriate actions and processes in accordance with a program stored in a read-only memory (ROM) 502 or a program loaded into a random access memory (RAM) 503 from a storage portion 508. The RAM 503 also stores various programs and data required by operations of the system 500. The CPU 501, the ROM 502 and the RAM 503 are connected to each other through a bus 504. An input/output (I/O) interface 505 is also connected to the bus 504.

The following components are connected to the I/O interface 505: an input portion 506 including a keyboard, a mouse etc.; an output portion 507 comprising a cathode ray tube (CRT), a liquid crystal display device (LCD), a speaker etc.; a storage portion 508 including a hard disk and the like; and a communication portion 509 comprising a network interface card, such as a LAN card and a modem. The communication portion 509 performs communication processes via a network, such as the Internet. A driver 510 is also connected to the I/O interface 505 as required. A removable medium 511, such as a magnetic disk, an optical disk, a magneto-optical disk, and a semiconductor memory, may be installed on the driver 510, to facilitate the retrieval of a computer program from the removable medium 511, and the installation thereof on the storage portion 508 as needed.

In particular, according to an embodiment of the present disclosure, the process described above with reference to the flow chart may be implemented in a computer software program. For example, an embodiment of the present disclosure includes a computer program product, which comprises a computer program that is tangibly embedded in a machine-readable medium. The computer program comprises program codes for executing the method as shown in the flow chart. In such an embodiment, the computer program may be downloaded and installed from a network via the communication portion 509, and/or may be installed from the removable media 511.

The flow charts and block diagrams in the figures illustrate architectures, functions and operations that may be implemented according to the system, the method and the computer program product of the various embodiments of the present invention. In this regard, each block in the flow charts and block diagrams may represent a module, a program segment, or a code portion. The module, the program segment, or the code portion comprises one or more executable instructions for implementing the specified logical function. It should be noted that, in some alternative implementations, the functions denoted by the blocks may occur in a sequence different from the sequences shown in the figures. For example, in practice, two blocks in succession may be executed, depending on the involved functionalities, substantially in parallel, or in a reverse sequence. It should also be noted that, each block in the block diagrams and/or the flow charts and/or a combination of the blocks may be implemented by a dedicated hardware-based system executing specific functions or operations, or by a combination of a dedicated hardware and computer instructions.

The units involved in the embodiments of the present application may be implemented by way of software or hardware. The described units may also be provided in a processor, for example, described as: a processor, comprising a receiving unit, a parsing unit, an information selecting unit and a generating unit, where the names of these units are not considered as a limitation to the units. For example, the receiving unit may also be described as “a unit for receiving a webpage browsing request of a user.”

In another aspect, the present application further provides a computer readable storage medium. The computer readable storage medium may be the computer readable storage medium included in the apparatus in the above embodiments, or a stand-alone computer readable storage medium which has not been assembled into the apparatus. The computer readable storage medium stores one or more programs. The one or more programs cause a device to, when being executed by the device: receive a file having predetermined identifiers; split the file into a plurality of subfiles based on a size of the file, a number of the predetermined identifiers in the file and a number of servers in the distributed system, each of the plurality of subfiles comprising an identical number of the predetermined identifiers; and send, in response to a file processing request sent by at least one of the servers in the distributed system, the plurality of subfiles to a corresponding server for parallel processing of the file.

The foregoing is only a description of the preferred embodiments of the present application and the applied technical principles. It should be appreciated by those skilled in the art that the inventive scope of the present application is not limited to the technical solutions formed by the particular combinations of the above technical features. The inventive scope should also cover other technical solutions formed by any combinations of the above technical features or equivalent features thereof without departing from the concept of the invention, such as, technical solutions formed by replacing the features as disclosed in the present application with (but not limited to), technical features with similar functions.

What is claimed is:

1. A method for processing a file in a distributed system, comprising:
receiving a file having predetermined identifiers;
splitting the file into a plurality of subfiles based on a size of the file, a number of the predetermined identifiers in the file and a number of servers in the distributed system, each of the plurality of subfiles comprising an identical number of the predetermined identifiers; and
sending, in response to a file processing request sent by at least one of the servers in the distributed system, the plurality of subfiles to a corresponding server for parallel processing of the file.

2. The method according to claim 1, wherein,
the number of the plurality of subfiles is an integer multiple of the number of the servers in the distributed system.

3. The method according to claim 1, further comprising, after the sending the plurality of subfiles to the corresponding server for the parallel processing of the file:
merging the subfiles processed by the corresponding server to generate a merged file; and
setting an access permission of the merged file to a share permission or a non-share permission.

4. The method according to claim 1, wherein the file is a genetic information file.

5. The method according to claim 1, wherein the splitting the file into the plurality of subfiles based on the size of the file, the number of the predetermined identifiers in the file and the number of the servers in the distributed system comprises:
determining a number of the plurality of subfiles to be generated and a number of the predetermined identifiers in each of the plurality of subfiles, based on the size of the file, the number of the predetermined identifiers in the file and the number of the servers in the distributed system; and
splitting the file into the plurality of subfiles based on the number of the plurality of subfiles to be generated and the number of the predetermined identifiers in each of the plurality of subfiles.

6. An apparatus for processing a file in a distributed system, comprising:
a receiving unit for receiving a file having predetermined identifiers;
a splitting unit for splitting the file into a plurality of subfiles based on a size of the file, a number of the predetermined identifiers in the file and a number of servers in the distributed system, each of the plurality of subfiles comprising an identical number of the predetermined identifiers; and
a parallel processing unit for sending, in response to a file processing request sent by at least one of the servers in the distributed system, the plurality of subfiles to a corresponding server for parallel processing of the file.

7. The apparatus according to claim 6, wherein, the number of the plurality of subfiles is an integer multiple of the number of the servers in the distributed system.

8. The apparatus according to claim 6, wherein, the parallel processing unit is further configured to:
merge the subfiles processed by the corresponding server to generate a merged file; and
set an access permission of the merged file to a share permission or a non-share permission.

9. The apparatus according to claim 6, wherein, the file is a genetic information file.

10. The apparatus according to claim 6, wherein, the splitting unit is further configured to:
determine a number of the plurality of subfiles to be generated and a number of the predetermined identifiers in each of the plurality of subfiles, based on the size of the file, the number of the predetermined identifiers in the file and the number of the servers in the distributed system; and
split the file into the plurality of subfiles based on the number of the plurality of subfiles to be generated and the number of the predetermined identifiers in each of the plurality of subfiles.

11. A non-transitory storage medium storing one or more programs, the one or more programs when executed by an apparatus, causing the apparatus to perform a method for processing a file in a distributed system, comprising:
receiving a file having predetermined identifiers;
splitting the file into a plurality of subfiles based on a size of the file, a number of the predetermined identifiers in the file and a number of servers in the distributed system, each of the plurality of subfiles comprising an identical number of the predetermined identifiers; and
sending, in response to a file processing request sent by at least one of the servers in the distributed system, the plurality of subfiles to a corresponding server for parallel processing of the file.
